(19) United States
(12) Patent Application Publication
(10) Pub. No.: US 2008/0184806 A1
(43) Pub. Date: Aug. 7, 2008

(54) Device for Measuring Perforation Resistance

(75) Inventor: Emilio Valentini, Firenze (IT)

Correspondence Address: GIFFORD, KRASS, SPRINKLE,ANDERSON & CITKOWSKI, P.C, PO BOX 7021, TROY, MI, 48007-7021, US

(73) Assignee: Sint Technology S.R.L.

(21) Appl. No.: 11/910,760

(22) PCT Filed: Apr. 5, 2006
(86) PCT No.: PCT/IB2006/000792

§ 371 Date: Oct. 5, 2007

(30) Foreign Application Priority Data
Apr. 6, 2005 (FI) 2005A000063

(51) Int. Cl. G01N 3/00

(52) U.S. Cl. 73/788

(57) ABSTRACT

The device according to the present invention relates to an instrument for measuring perforation resistance.

### FIELD OF THE INVENTION

The present invention relates to the field of devices used to measure the drilling resistance of materials, in particular to the field of devices for measuring the perforation resistance of materials.

### PRIOR ART

In the field of the methods and instruments used to measure the hardness of materials, the devices used to measure perforation resistance are of particular importance.

The determination of perforation resistance not only provides indications about the strength of the material, it also provides information about the state of conservation of said material and the penetration of any strengthening products that may be applied, an aspect of particular importance, for example, in the conservation of old monuments and buildings.

Traditional methods for determining the strength of materials consist of analysing samples which are taken from the structure being examined and then tested to determine their compression, flexural and tensile strength.

This method has a number of drawbacks: firstly, the characteristics that are measured partly depend on the size and shape of the sample being analysed. Furthermore, taking samples from old buildings and monuments may be difficult and unadvisable. The use of methods that allow tests to be performed in situ and that leave the least possible trace on the object being examined is therefore desirable.

A series of alternative micro-destructive or semi-destructive measuring techniques have therefore been developed, which assess physical properties of the material that were not previously analysed but which are related to the actual strength of the material.

One such alternative technique, which has gained particular importance, is the measurement of perforation resistance, a micro-destructive technique that can be performed in situ and, when carried out under certain operating conditions, provides valuable information about the “quality” of the material being analysed.

The devices currently available for measuring perforation resistance are often bulky, complicated to install and use and require special care when assembling. This makes them difficult to use in many cases, especially when carrying out in situ analyses on monuments and old buildings.

On the basis of that stated above it is clear that, given the particular importance of measuring perforation resistance as a means of determining the condition of buildings, constructions, monuments, statues, etc., there is a need for instruments and devices capable of performing said measurement in a convenient, efficient and reproducible manner while being easily transportable and simple and versatile to use.

The purpose of the present invention is thus to produce a hand-held device for measuring perforation resistance that: a) is more manageable and easier to use than the devices currently available, b) assures the metrological traceability of the parameter measured (for example force and torque), c) can be used in any direction (even in a vertical direction).

Another purpose of the present invention is to produce a hand-held device for measuring perforation resistance by modifying tools such as drills, drill/drivers and similar tools commonly available on the market.

### SUMMARY OF THE INVENTION

Device for measuring perforation resistance characterized in that it comprises a central element provided with a handgrip, a control box connected to said central element and a mandrel connected to said control box.

### BRIEF DESCRIPTION OF THE DRAWINGS

FIG. 1 Cross-sectional view of the device according to the present invention, complete with supporting and drilling plate

FIG. 2 Cross-sectional view of the device according to the present invention, complete with belt drive assembly and motor reducer

FIG. 3 Block diagram of the electronic control circuit of the device according to the present invention

### DETAILED DESCRIPTION OF THE INVENTION

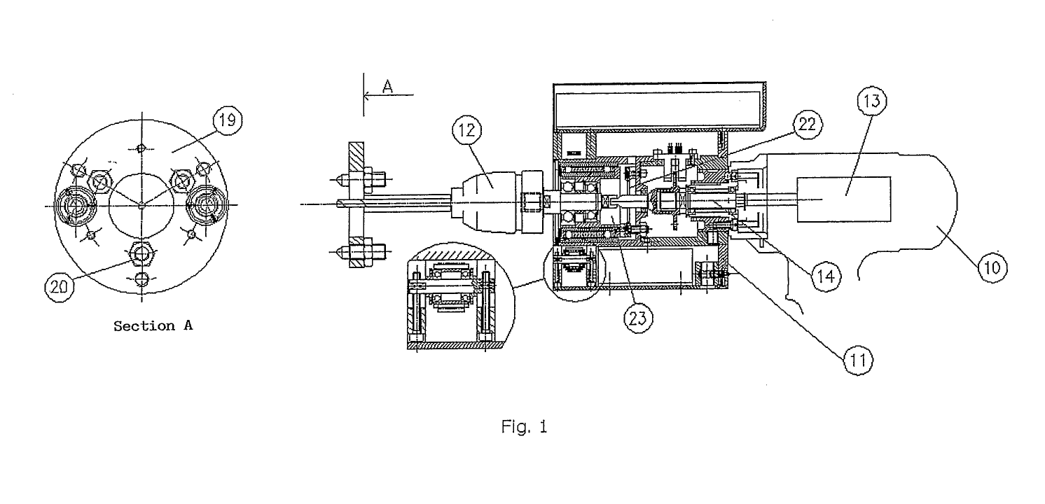

The device for measuring perforation resistance according to the present invention is illustrated in an assembly drawing in FIG. 1.

Said device comprises a central element 10 provided with a handgrip, a control box 11 connected to said central element 10 and a mandrel 12 connected to said control box 11.

The principle on which the device for measuring perforation resistance according to the present invention is based consists of the continuous measurement, during drilling, of the force (or torque) required to drill said hole, maintaining a constant speed of rotation and advance speed of the drill.

Also with reference to FIG. 1, a preferred embodiment of the device according to the present invention is illustrated in greater detail. Inside the central element 10 there is housed a first electric motor 13 that is associated with and transmits a rotary motion to a shaft 14 that passes through said control box 11 until reaching said mandrel 12 to which it is rigidly connected.

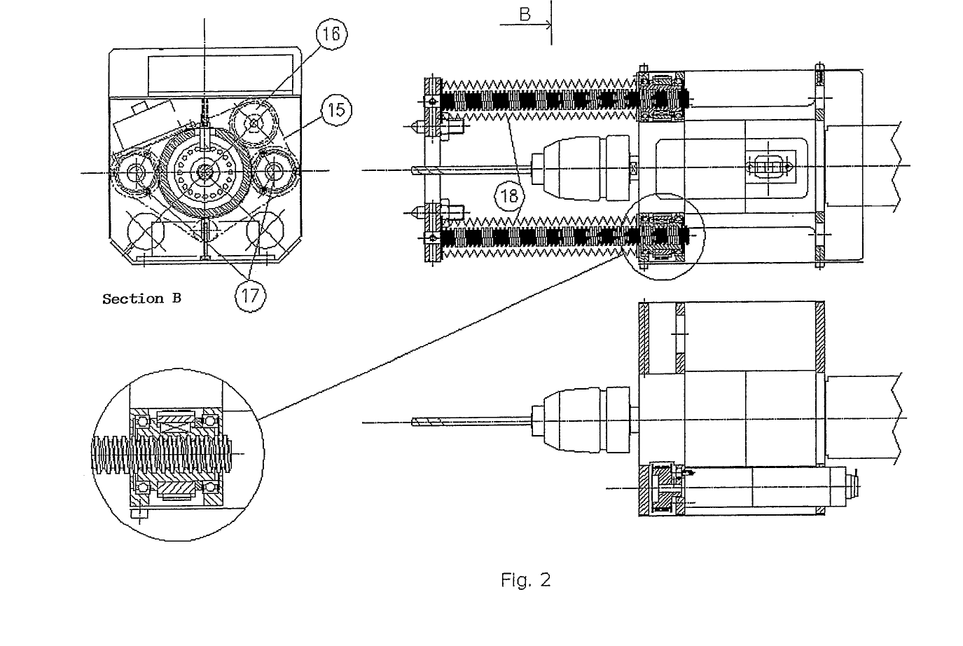

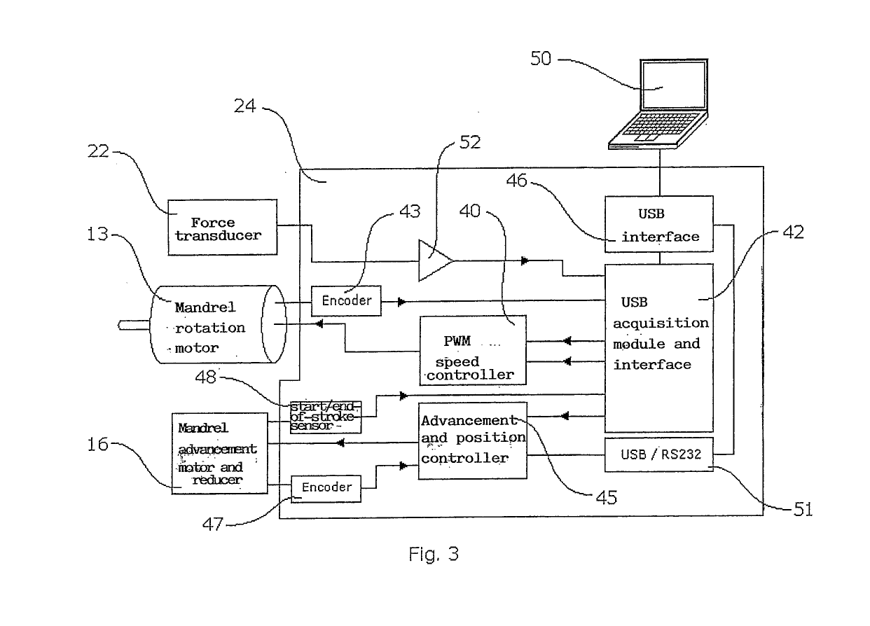

With reference to FIG. 2 attached hereto, said control box 11 comprises an assembly 16 consisting of a second motor associated with a reducer, a transmission assembly 15 associated with said assembly 16, a device for measuring the applied force—for example a load cell—22, a floating element 23 that allows the applied force to be transferred directly to said load cell 22 and a control assembly 24, illustrated in detail in FIG. 3

The transmission assembly 15, which is preferably of the belt drive type, operates in such a way as to transmit the rotary motion of said motor-reducer assembly 16 to a pair of lead screws 17 that in turn determine the translation of the pair of screws 18, rigidly connected to one another by means of a supporting and drilling plate 19 an example of which is shown in FIG. 1.

Said plate 19 is provided with three adjusting screws 20 for fixing to the surfaces of the materials to be analysed, and three holes for anchoring to a relative counter-plate to perform measurements directly on the samples.

During the operation of the device according to the present invention, the rotary motion of the mandrel 12 is generated by the motor 13 via the transmission shaft 14; the drilling resistance applied to said mandrel 12 is applied and transferred directly to the load cell 22 via said floating element 23, which is movable in relation to the axis of drilling and rotation.

In another preferred embodiment of the device, drilling is performed by means of a device for orbital drilling associated with said mandrel 12 in such a way that the axis of rotation of the drill is not fixed but revolves around a point.

Using this method it is possible to achieve a more efficient evacuation of shavings, increase the life of cutting points and thus drill a wider range of materials. Said device for orbital drilling may for example consist of an auxiliary motor or a gear pair.

The device according to the present invention may be managed by a PC, tablet PC or similar external unit 50 connected to the control assembly 24, housed in the control box 11, of which the internal layout is illustrated in the block diagram in FIG. 3.

The rotary motion of the mandrel 12 is enabled and controlled by means of an electric drive 40 that controls the relative motor 13 governed in turn by the analog outputs of a USB acquisition module 42 provided with an appropriate interface for connection to said electric drive 40. The speed of rotation of the mandrel 12 is detected by a first device 43—suited for reading the number of revolutions per minute, preferably an encoder which monitors the number of revolutions per minute of said mandrel—and then fed back by the control software.

The advancement of the mandrel 12 is controlled by means of said motor-reducer assembly 16 and an appropriate advancement and position controlling device 45, managed by a USB/RS232 converter 51 connected to the USB interface module 46. Said advancement and position controlling device 45 also manages, by means of a second device 47 for monitoring the number of revolutions per minute—preferably a high resolution encoder—associated with the assembly 16, the advancement of the mandrel by controlling its acceleration, torque, direction and speed parameters (the latter is maintained constant).

Said advancement and position controlling device 45 also manages the signals from the start and end-of-stroke sensor 48, providing a hardware protection of the mechanical movements of the system.

The signals from the two start and end-of-stroke sensors 48 are also acquired by the USB acquisition module 42, and read by the external control unit 50 by means of an appropriate software programme.

The drilling resistance of the material being analysed is determined by means of said device for measuring the applied force 22, preferably comprising a load cell, the output signal of which, that may be amplified by means of an appropriate amplifying module 52, is sent to the USB acquisition module 42 together with the transducer supply voltage and the system supply voltage.

An appropriate software programme, made to run on the external control unit 50 manages and controls all movements and enables the setting of the relative parameters for the material to be drilled and for the actual hole (depth, drill bit diameter and resolution as well as the speed of rotation and advancement). The data that are acquired are stored in a file and made available for future processing and analyses, for example to create graphs displaying several acquisitions simultaneously and regarding the patterns of the drilling forces required as a function of the depth of said drilling.

1. Device for measuring perforation resistance comprising a central element (10) provided with a handgrip, a control box (11) connected to said central element (10) and a mandrel (12) connected to said control box (11).

2. Device for measuring perforation resistance according to claim 1 characterized in that said central element (10) comprises a first electric motor (13) that is associated with and transmits rotary motion to a shaft (14) rigidly connected to said mandrel (12).

3. Device for measuring perforation resistance according to claim 2 wherein said first electric motor (13) is associated with an electric drive (40) controlled in such a way as to determine and maintain constant the speed of rotation of the mandrel (12).

4. Device for measuring perforation resistance according to claim 3 wherein said control box (11) comprises an assembly (16) consisting of a second motor coupled to a reducer, a transmission assembly (15) connected to said assembly (16), a device for measuring the applied force (22), a floating element (23) that allows the applied force to be transferred directly to said device (22) for measuring the applied force and a control assembly (24).

5. Device for measuring perforation resistance according to claim 4 wherein said device (22) for measuring the applied force consists of a load cell

6. Device for measuring perforation resistance according to claim 5 comprising a pair of lead screws (17) associated with a pair of screws (18), rigidly connected to one another by means of a supporting and drilling plate (19).

7. Device for measuring perforation resistance according to claim 6 wherein said transmission assembly (15) is also associated with said pair of lead screws (17) in such a way as to transmit the rotary motion of said motor-reducer assembly (16) to said pair of lead screws (17)

8. Device for measuring perforation resistance according to claim 7 wherein said transmission assembly (15) is of the belt drive type.

9. Device for measuring perforation resistance according to claim 8 wherein said plate (19) is provided with adjusting screws (20) for fixing to the surfaces of the materials to be analysed, and holes for anchoring to a counter-plate.

10. Device for measuring perforation resistance according to claim 9 comprising it comprises a device for orbital drilling associated with said mandrel (12).

11. Device for measuring perforation resistance according to claim 10 wherein said device for orbital drilling consists of an auxiliary motor.

12. Device for measuring perforation resistance according to claim 10 wherein said device for orbital drilling consists of a gear pair.

13. Device for measuring perforation resistance according to claim 12, wherein said control assembly (24) comprises: an electric drive (40) associated with said first motor (13), a first device (43) for monitoring the number of revolutions per minute associated with said first motor (13), an advancement and position controlling device (45) associated with said assembly (16), a start and end-of-stroke sensor (48) associated with said assembly (16), a second device (47) for monitoring the number of revolutions per minute associated with said assembly (16), a USB acquisition module (42) provided with an appropriate interface for connection to said electric drive (40), an amplifying module (52) associated with said device for measuring the applied force (22).

14. Device for measuring perforation resistance according to claim 13, wherein said control assembly (24) also comprises a USB interface module (46) and a USB/RS232 converter (51) associated therewith.

15. Device for measuring perforation resistance according to claim 14, wherein said devices for monitoring the number of revolutions consist of encoders.

16. Device for measuring perforation resistance according to claim 15, comprising an external control unit (50) associated with said control assembly (24).

17. Device for measuring perforation resistance according to claim 16, wherein said external control unit (50) consists of a PC or tablet PC.
